(19) United States
(12) Patent Application Publication
(10) Pub. No.: US 2011/0146347 A1
(43) Pub. Date: Jun. 23, 2011

(54) Magnetic jewelry

(76) Inventor: Jeffrey Dunmire, Las Vegas, NV (US)

(21) Appl. No.: 12/924,282

(22) Filed: Sep. 22, 2010

Related U.S. Application Data
(63) Continuation of application No. 12/316,505, filed on Dec. 12, 2008, now abandoned.
Application No. 12/316,505 is a continuation of application No. 10/829,135, filed on Apr. 21, 2004, now abandoned.
(60) Provisional application No. 60/497,352, filed on Aug. 22, 2003.

(51) Int. Cl. A44C 5/00; A44C 25/00; H01F 7/02

(52) U.S. Cl. 63/3.1; 63/33

(57) ABSTRACT

An article of jewelry includes at least one body having a top and bottom face. The body is constructed of a precious or semi-precious metal. In one embodiment, the metal is titanium. A magnetic element is connected to the body. In one embodiment, the magnetic element has a face or surface which comprises at least 50%, and preferably 75% to 90%, of the total area of the bottom face of the body. In one embodiment, the body comprises a link, and a plurality of the links are connected to form a bracelet. In one embodiment, the magnetic element is generally oval in shape and is inset into the body so that the face of the magnetic element is co-planar with the rear of the body.

### RELATED APPLICATION DATA

This application is a continuation of U.S. patent application Ser. No. 12/316,505 filed Dec. 12, 2008, which is a continuation of U.S. patent application Ser. No. 10/829,135, filed Apr. 21, 2004, now abandoned, which claims priority to U.S. Provisional Application Ser. No. 60/497,352 filed Aug. 22, 2003.

### FIELD OF THE INVENTION

The present invention relates to wearable jewelry and ornaments, and particularly to such made of precious or semi-precious metals and including magnetic material.

### BACKGROUND OF THE INVENTION

Magnetics have long been known to have an effect upon the human body. Many people have found that magnetics have substantial health benefits. For example, people have found that exposure to magnetic results in various healing effects, including reduced pain and swelling. Other stated benefits have been reported, including increased stamina.

One method of exposing the body to magnetics is to place magnetic material adjacent the body. For example, as described in U.S. Pat. No. 4,095,587, magnetic material may be located in capsules connected to a chain. When the chain is worn, the magnetic material is located proximate the body.

There are numerous problems or issues to consider when attempting to address a configuration for locating magnetics close to the body. One issue is aesthetics. So that the wearer can frequently wear the magnetic material, it is desirable that the item be aesthetically pleasing. For example, a person could wear a block of magnetic material, such as hematite, connected to a string around their neck. However, this would be unappealing and unacceptable in most settings.

In this regard, the magnetic material may be associated with jewelry, such as described in U.S. Pat. No. 4,095,587. However, there are additional considerations. As indicated above, it is desirable to wear the magnetic material most of the time, or for long periods of time. Contact with many materials results in discoloration of the skin or irritation of the skin. In addition, wearing of these materials generally subjects them to body acids, sweat, water and other materials which may result in corrosion of the material.

Also, some have found it desirable to increase the amount of magnetic material to which they are exposed. However, it is desirable to do this without making configuration less aesthetically appealing.

### SUMMARY OF THE INVENTION

An article of jewelry or ornamentation includes a magnetic element.

One embodiment of the invention is an article of jewelry constructed substantially or primarily from titanium. In one embodiment, the article of jewelry is a bracelet comprising a plurality of joined links. The links are constructed primarily from titanium. One or more magnetic elements are associated with the jewelry. In one embodiment, each link has a top or front face and a bottom or rear face. At least one magnetic element is located in or at the rear face of one or more of the links, so that when the article of jewelry is worn, the magnetic element is located adjacent the wearer's body.

Another embodiment of the invention is an article of jewelry which is constructed of another precious or semi-precious metal such as gold, silver, platinum. A magnetic element is connected to a body comprising the article. In one embodiment, the magnetic element is mounted in an inset or recess formed in the body.

In one embodiment, the magnetic element has a face or surface which comprises at least 50%, more preferably comprises about 75% or more, and most preferably comprises about 90% or more of the total area of the rear or bottom of the body.

In one embodiment, the body comprises a link, and a plurality of the links are connected to form a bracelet. In this embodiment, the magnetic elements preferably also extend along approximately 75%-90% of the total distance traversed by the links.

In one embodiment, the magnetic element is generally oval in shape and is inset into the body so that the face of the magnetic element is co-planar with the rear of the body.

In accordance with the invention, an article of jewelry includes one or more magnetics. The body of the article is constructed of a material with is compatible with the human body, which does not corrode, and which will not result in discoloration. In one embodiment, the article is constructed to maximize the amount of magnetic material which is located proximate to or in contact with the body, when considering the size or area of the article.

Further objects, features, and advantages of the present invention over the prior art will become apparent from the detailed description of the drawings which follows, when considered with the attached figures.

### DESCRIPTION OF THE DRAWINGS

FIG. 1 illustrates two embodiments of a bracelet in accordance with the present invention; and

FIG. 2 is an enlarge view of a link element including magnetic material in accordance with one embodiment of the present invention.

### DETAILED DESCRIPTION OF THE INVENTION

The invention is an article of magnetic jewelry and a method for constructing the same. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is an article of jewelry or other ornamentation which includes magnetic material. The term “jewelry” is used herein to denote and article which is generally aesthically appealing and which is intended to be worn by a human.

One aspect of the invention is an article of jewelry which includes one or more magnetic elements or magnetic areas. In one embodiment, the article of jewelry is constructed primarily from titanium (Ti). The article of jewelry is preferably a bracelet comprising a plurality of connected links. Magnetic elements are associated with one or more of the links.

In another embodiment of the invention, the jewelry is constructed from a precious or semi-precious metal such as gold (Au), platinum (Pt), silver (Ag) or titanium. The jewelry includes one or more magnetic elements or areas. In one embodiment, more than 50%, preferably more than 75%, and most preferably about 90% or more of a contact area of the jewelry is magnetic material, providing a great deal of exposure of the human body to the magnetic material. These and other aspects of the invention will now be described in detail with reference to various particular embodiments of the invention.

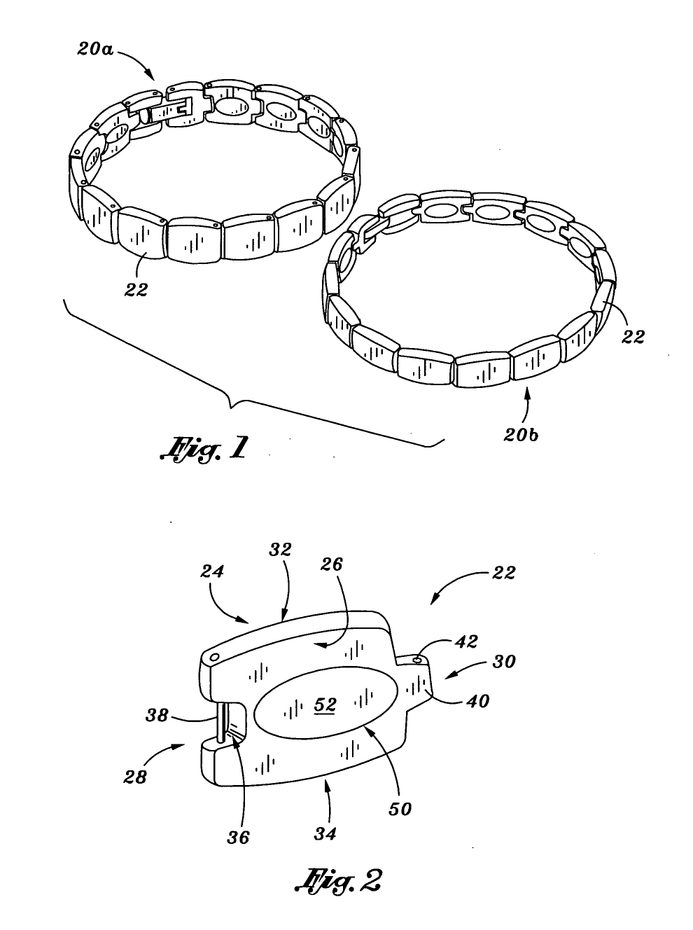

FIG. 1 illustrates one preferred embodiment of the invention. This figure illustrates two bracelets 20a,b. The bracelets 20a,b comprises a plurality of links 22 which are interconnected. As illustrated, the two bracelets 20a,b are similar, differing primarily only in the size/shape of the links 22 used to form the bracelet 20a,b.

The links 22 may have variety of shapes and sizes. FIG. 2 illustrates one embodiment link 22 in greater detail. In general, each link 22 has a front or top surface 24 and a rear or bottom surface 26. When the bracelet 20 is worn, the front or top surface 24 of each link 22 generally faces away from the wearer, while the rear or bottom surface 26 is located adjacent to and generally faces the wearer. For example, when worn on the wrist, the rear surface 26 of each link is located adjacent the skin of the wrist of the wearer and is thus not readily visible, while the front surface 24 faces outwardly and is generally visible.

In one embodiment, the links 22 have a first end 28 and a second end 30. In one embodiment, one or more of the links 22 are connected at the first and second ends 28,30 to other of the links. Each link 22 has a length which comprises the distance from its first end 28 to its second end 30.

The links 22 illustrated generally have a first edge 32 and a second edge 34. The distance between these edges 32,34 generally defines the width of the link 22, and thus the width of the bracelet 20.

As illustrated in FIG. 2, the link 22 has a generally rectangular shape, with the first and second edges 32,34 generally extending parallel to one another and generally perpendicular to the first and second ends 28,30. The length of the link 22 is slightly greater than its width. As indicated above, the particular shape of the link 22 may vary. For example, as illustrated in FIG. 1, the links 22 of the bracelet 20b are much greater in length than they are in width.

In one or more embodiments, the links 22 may have a shape other than rectangular, such as oval, circular or square. As described below, the, generally rectangular shape is preferred because it maximizes the magnetic material surface area.

The links 22 may be constructed from a variety of materials. Preferably, however, the links 22 are constructed from a precious or semi-precious metal. Preferably, the metal is one which is corrosion resistant and will not discolor the skin. Such metals may include gold (Au), silver (Ag), platinum (Pt.) and combinations thereof. In a preferred embodiment, the links are constructed from titanium (Ti). Use of titanium has these features, and the added benefit of substantial strength and durability, as well as a low mass/weight. As described below, a particular advantage of the use of titanium is in the strength of the link 22.

The particular thickness of the link 22 from its front to its rear surface 24,26 may vary. In one embodiment, each link 22 is about 2-5, and most preferably 3.5 mm in thickness. Preferably, the links are generally thin to minimize the weight of the bracelet 20.

As indicated above, a plurality of links 22 are preferably connected to one another. Preferably a number of the links 22 are generally permanently connected. As illustrated in FIG. 2, the links 22 may include an inwardly extending notch 36 at the first end 28 thereof. A pin 38 may extend across the notch 26. The link 22 may also include an extension or tongue 40 at the second end 30. The extension 40 may include a passage 42 for accepting the pin 38. The extension 40 of one link 22 is preferably engaged with the notch 36 and pin 38 of the next link 22, thereby joining the links. In this embodiment, the links 22 may move relative to one another.

In general, a variety of means may be used to connect the links 22. Preferably, at least two of the links 22, such as end links, may be readily connected from one another, such as with a clasp. As illustrated, such links need not include a magnetic element, but may simply be clasp links or members. This allows the user to open the bracelet 20 to place it on their wrist, and then re-secure it. Such methods and configurations are well known to those of skill in the art.

Most importantly, a magnetic element 50 is preferably associated with one or more links 22 of the bracelet 20. The magnetic element 50 may comprise a wide variety of material, such as those identified in U.S. Pat. No. 4,095,587, which is incorporated herein by reference.

Preferably, a magnetic element 50 is associated with each link 22. As illustrated in FIG. 2, the magnetic element 50 is mounted to the link 22. Preferably, the magnetic element 50 is mounted so that a face 52 thereof faces in generally the same direction as the rear surface 26 of the link 22.

In the preferred embodiment, as illustrated, the magnetic element 50 is mounted within the link 22, and the face 52 of the magnetic element 50 is generally co-planar with the rear surface 26 of the link 22. The magnetic element 50 may be mounted to or associated with the link 22 in a variety of manners. In one embodiment, the rear surface 26 of the link 22 is formed with a depression, inset or recess for accepting the magnetic element 50. In one embodiment, the link 22 is formed (such as in a molding process) or machined to include the inset or recess. The magnetic element 50 is then affixed, connected or mounted to the link 22. The magnetic element 50 may be affixed in a variety of manners. It is also possible for the magnetic element 50 to comprise a portion or area of the link 22, such as in a molding process.

As will now be appreciated, the face 52 of the magnetic element 50 preferably comprises a portion or part of the surface area of the bracelet 20 which is in contact with or in close proximity to the wearer when the bracelet 20 is worn. In accordance with the present invention, the link 22, including the magnetic element 50, is configured to maximize the exposed surface area of magnetic element 50 relative to the total (rear) surface area of the link 22, and thus to maximize the amount of area of contact of the magnetic material with the user.

As illustrated, in a preferred embodiment, the magnetic element 50 (or at least the face thereof) is generally oval in shape. The element or area may have other shapes, such as circular or square. The magnetic element 50 is generally centered in the rear face 26 of the link 22. In a preferred embodiment, the face 52 of the magnetic element 50 comprises more than 50%, more preferably about 75% or more, and most preferably about 90% or more of the total area of the rear surface 26 of the link (including the magnetic element 50). In this manner, the amount of magnetic material which is located in close proximity to or in contact with the user is maximized relative to the size of the bracelet 20.

In the preferred embodiment as illustrated, a first end of the magnetic element 50 is located adjacent to, but inset slightly from, the notch 36 in the first end 28 of the link 22. The magnetic element 50 extends to a second end thereof which is preferably aligned with the portion of the second end 30 of the link 22, excluding the extension 40. This configuration has the advantage of maximizing the length of the magnetic element 50 associated with the link 22 without compromising the strength and durability of the link 22.

The oval shape of the magnetic element 50 has a number of advantages. First, this shape allows for maximum magnetic element surface area relative to the total area of the link 22. In addition, the curved edges of the magnetic element 50 and of the associated inset or depression in the link 22 reduce the probability of failure of the element 50 or link 22, including as a result of cracking or the like.

When the links 22 are connected they form a generally closed loop or ring. In a preferred embodiment, the magnetic elements 50 extend approximately 75% to 90%, and more preferably about 90% or more, of the total length or distance around the interior of the loop or ring formed by the links 22.

In one embodiment, the link 22 is about 11.5 mm in length and the magnetic element 50 is about 7.5 mm in length. The distance from the end of the magnetic element 50 to the notch 36 is about 1 mm. The distance from the opposing end of the magnetic element 50 to the first end 30 of the link 22, not including the extension or tongue 40, is about 1 mm. The distance from the end of the magnetic element 50 to the end of the extension or tongue 40 is about 3-3.5 mm. In general, it is desirable for the “wall” thickness of the body (such as link) surrounding the magnetic element be no less than about 1 mm in order to ensure structural integrity.

In one embodiment, the magnetic element 50 which is associated with the link 22 comprises a single body or member. In other embodiments, a plurality of individual magnetic elements 50 may be associated with the link 22. Thus, as used herein, the term “magnetic element” is intended to be construed to include one or more elements.

In other embodiments, the magnetic elements may be located in some, but not all, of the links.

It will be appreciated that the principles of the invention may be applied to other jewelry or ornamentation. For example, links having associated magnetic elements may be connected to form a necklace. The links may also form a watch band.

In other configurations, the principles may be applied to individual elements or other elements. For example, the article of the invention may comprise a pendant. In these other configurations, the invention may have a form other than a link, and simply comprise a body containing or having an associated magnetic element. For example, the bracelet may be a generally “C”-shaped element (i.e., one-piece instead of a plurality of links) and the magnetic element(s) may be associated therewith.

It will be appreciated that the shape and size of such elements may vary. Preferably, however, the element or article comprises a body which is constructed in whole or in part of the material described above, and includes magnetic element.

The invention has a number of advantages. First, the body of the jewelry, such as the link(s), is constructed from a material which will not corrode, cause skin discoloration or the like. At the same time, the material is aesthetically pleasing. In the preferred embodiment, use of titanium has the significant advantage that while having these characteristics, it is also much lighter in mass for the same size body. In fact, the same body constructed of titanium versus other gold and similar materials may be 40% to 60% lighter.

Most importantly as well, the amount of magnetic material which is located in close proximity to or in contact with the body is maximized. In particular, when considering the total adjacent surface area of the article (such as the total area of the inside surface of the bracelet), the magnetic material comprises more than 50%, preferably more than 75%, and most preferably 90% or more of the total area. In this manner, for a given size article, the magnetic material exposure is maximized.

Another advantage is that, while the magnetic material area is maximized, the strength and durability of the article is not compromised. In a preferred embodiment, the magnetic material is in the shape of an oval and located in a similarly shaped inset or recess in the body. This configuration minimizes stresses and the probability of cracks and other breakage. In addition, the oval or other elongate shape allows the magnetic material to form a near continuous or contiguous length of magnetic material. In the case of a bracelet, for example, this means the magnetic material nearly encircles the interior of the bracelet.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. An ornamental element configured to be worn adjacent the body of a wearer, the ornamental element comprising a plurality of connected non-oval links having a front and a rear, said links constructed from solid titanium, and a magnetic element associated with each of said links, the magnetic element connected to the link, the magnetic element having a face, said face generally co-planar with at least a portion of said rear of said link, a surface area of said face of said magnetic element comprising at least 50% of a total area comprising the rear of said link and said face of said magnetic element, and including a clasp member at opposing ends of said plurality of connected links, said clasp members configured to be selectively connected to connect said plurality of connected links into a closed loop.

2. The ornamental element in accordance with claim 1 wherein said face of said magnetic element is oval in shape.

3. The ornamental element in accordance with claim 2 wherein said links are generally rectangular in shape.

4. A bracelet configured to be worn adjacent the body of a wearer, said bracelet comprising a plurality of non-oval links, one or more of said links connected to one another, each link having a front and a rear, said links constructed from a solid precious metal selected from the group consisting of gold, silver, platinum and titanium, substantially all of said links having an associated magnetic element, each magnetic element having a face, said face generally co-planar with at least a portion of said rear of said link to which it is connected, a surface area of said face of said magnetic element comprising at least 50% of a total area comprising the rear of said link and said face of said magnetic element.

5. The bracelet in accordance with claim 4 wherein said face of said magnetic element comprises at least about 75% of the total area comprising the rear of said link including said magnetic element.

6. The bracelet in accordance with claim 4 wherein said magnetic elements are oval in shape.

7. The bracelet in accordance with claim 4 wherein each link is generally rectangular in shape, having a first end and a second end, said first end including an outwardly extending tongue and said second end including an inwardly extending notch, the tongue of one or more links located in the notch of an adjacent link.

8. The bracelet in accordance with claim 7 including means for selectively connecting at least two of the links so that said bracelet may be formed into a closed loop or opened to be placed on a wearer.

9. A bracelet configured to be worn on the body of a wearer, the bracelet comprising a plurality of precious metal non-oval links connected to one another end to end and having a pair of clasp links at opposing ends of the bracelet, the precious metal links having a front and a back and a length between ends thereof being greater than a width, and a magnetic element associated with each of said precious metal links, said magnetic element having a face which is generally co-planar with a back of the link with which is associated, the magnetic element being oval in shape, with an elongate portion of said oval magnetic element aligned in a length-wise direction of said link.

10. The bracelet in accordance with claim 9 wherein said plurality of precious-metal links have a notch at a first end and an outwardly extending tongue at an opposing second end and wherein said magnetic element is offset in a lengthwise direction along said link by a distance which said notch extends into said first end.

11. The bracelet in accordance with claim 10 wherein said face of said magnetic element comprises at least 50% of a total area comprising a back of said precious-metal link including said magnetic element.

12. The bracelet in accordance with claim 11 wherein said one or more precious-metal links comprise solid precious metal selected from the group consisting of: gold, silver, platinum and titanium.
